(19) United States
(12) Patent Application Publication
(10) Pub. No.: US 2026/0189946 A1
(43) Pub. Date: Jul. 2, 2026

(54) PATH LOSS DETERMINATION BASED ON MEASUREMENTS FOLLOWING TRANSMISSION

(71) Applicant: Microchip Technology Incorporated, Chandler, AZ (US)

(72) Inventors: Karthikeyan Jegatheesan, Chennai (IN); Saravanakumar Sundaram, Chennai (IN)

(73) Assignee: Microchip Technology Incorporated, Chandler, AZ (US)

(21) Appl. No.: 19/178,281

(22) Filed: Apr. 14, 2025

(30) Foreign Application Priority Data
Dec. 27, 2024 (IN) 202411103918

(51) Int. Cl. H04W 24/08; H04B 17/318

(52) U.S. Cl. CPC H04W 24/08; H04B 17/318

(57) ABSTRACT

A wireless communication device includes a communication element, non-transitory computer-readable storage media including instructions stored thereon, and at least one processor. The instructions, when executed by the at least one processor, cause the at least one processor to: transmit, by the communication element, a first signal; during a pre-defined time period following the transmission of the first signal, detect, by the communication element, a second signal; responsive to detecting the second signal, perform, during the pre-defined time period, a measurement; and determine path loss based on the measurement.

### CROSS-REFERENCE TO RELATED APPLICATIONS

The current patent application claims the benefit under 35 U.S.C. § 119(a) of the priority date of Indian Provisional Application No. 202411103918 titled “PATH LOSS PREDICTOR USING RSSI MEASUREMENT IN SIFS AND LIFS DURATION AFTER TRANSMISSION”; and filed Dec. 27, 2024. The Provisional Application is hereby incorporated by reference, in its entirety, into the current patent application.

### TECHNICAL FIELD

Various examples of the present disclosure relate to systems and methods for path loss determination based on measurements following transmission of a signal.

### BACKGROUND

Over-the-air data collision is a common occurrence in a congested communication network. Over-the air data collision may cause path loss, which leads to further congestion due to dedication of additional resources to transmit a data packet multiple times. Excessive congestion may lead to poor network performance.

This background discussion is intended to provide information related to the present invention which is not necessarily prior art.

### SUMMARY OF THE INVENTION

According to various examples of the present disclosure, a wireless communication device includes a communication element, non-transitory computer-readable storage media including instructions stored thereon, and at least one processor. The instructions, when executed by the at least one processor, cause the at least one processor to: transmit, by the communication element, a first signal; during a pre-defined time period following the transmission of the first signal, detect, by the communication element, a second signal; responsive to detecting the second signal, perform, during the pre-defined time period, a measurement; and determine path loss based on the measurement.

According to various examples of the present disclosure, a wireless communication device includes a communication element, non-transitory computer-readable storage media including instructions stored thereon, and at least one processor. The instructions, when executed by the at least one processor, cause the at least one processor to: transmit, by the communication element, a signal; determine that an acknowledgment signal was not received during a first pre-defined time period following the transmission; responsive to determining that an acknowledgement signal was not received, transmit, by the communication element, a retransmitted signal; perform a measurement during a second pre-defined time period following transmission of the retransmitted signal; and determine path loss based on the measurement.

According to various examples of the present disclosure, a wireless communication device includes a communication element, non-transitory computer-readable storage media including instructions stored thereon, and at least one processor. The instructions, when executed by the at least one processor, cause the at least one processor to: transmit, by the communication element, a signal; during a pre-defined time period following the transmission of the signal, perform a measurement; determine path loss based on the measurement; responsive to determining the path loss, adjust a transmission parameter; and transmit, by the communication element, a retransmitted signal using the adjusted transmission parameter.

This summary is not intended to identify essential features of the examples, and is not intended to be used to limit the scope of the claims. These and other aspects of the present examples are described below in greater detail.

### BRIEF DESCRIPTION OF THE DRAWINGS

FIG. 1 illustrates an environmental view of example system for path loss determination based on measurements following transmission of a signal;

FIG. 2 illustrates an example computing system configured to perform operations in accordance with the various examples of the present disclosure;

FIG. 3A is a wireless communication timing diagram including short and long interframe spacing periods;

FIG. 3B is a wireless communication timing diagram including short and long interframe spacing periods;

FIG. 4 illustrates an environmental view of the system of FIG. 1 including a transmitting device and an interfering device;

FIG. 5A illustrates an example method for path loss determination based on measurements following transmission of a data packet;

FIG. 5B illustrates an example method for retransmitting a signal following a path loss determination;

FIG. 6 illustrates another example method for path loss determination based on measurements following transmission of a data packet; and

FIG. 7 illustrates another example method for path loss determination based on measurements following transmission of a data packet.

Unless otherwise indicated, the figures provided herein are meant to illustrate features of examples of this disclosure. These features are believed to be applicable in a wide variety of systems comprising one or more examples of this disclosure. As such, the figures are not meant to include all conventional features known by those of ordinary skill in the art to be required for the practice of the examples disclosed herein.

### DETAILED DESCRIPTION

In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure. Unless clearly understood or expressly identified otherwise, structures, materials, procedures, operations, and other aspects described in the context of one example may be incorporated into other examples.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

Terms of relative location and direction (e.g., above, below, left, right, upper, lower) may be used to facilitate the present descriptions of examples with reference to the figures, but unless clearly understood or expressly identified otherwise, these terms are not meant to be limiting with regard to location, direction, or overall orientation, and may, for example, change as a result of a change in overall orientation.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, operations, features, functions, or the like.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples.

Various examples of the present disclosure may be used in low power, low data rate wireless communication devices configured to operate using carrier sense multiple access with collision avoidance (CSMA-CA) network protocols, including Institute of Electrical and Electronics Engineers (IEEE) 804.15.4 network protocols. Examples of such devices include internet of things (IoT) devices, lighting systems, home automation devices, industrial automation devices, industrial sensors, and the like. It is contemplated that other devices, such as those configured to operate using IEEE 804.11 protocols, may utilize the path loss determination operations described herein without departing from the spirit of the present disclosure.

In various examples of the present disclosure, a wireless communication device may transmit a signal. The signal may include a data packet. Following transmission of the signal, the wireless communication device may perform a measurement. The measurement may be performed in a pre-defined time period following transmission, such as a short interframe spacing (SIFS) period or a long interframe spacing (LIFS) period. The measurement may include a clear channel assessment (CCA) measurement. The CCA measurement may include received signal strength indicator (RSSI) measurements and/or carrier sense measurements. The wireless device may determine that the previously transmitted signal likely experienced path loss and may not have reached its intended destination. The wireless device may adjust one or more transmission parameters to compensate for the path loss and transmit a retransmitted signal using the adjusted transmission parameter(s). The retransmitted signal may include the data packet.

RSSI measurements may include detecting one or more signal(s) during the pre-defined time period and measuring a signal strength of the detected signal(s). The RSSI of the detected signal(s) may be compared to a pre-defined energy threshold. If the RSSI exceeds the pre-defined energy threshold, the detected signal(s) may cause path loss. The detected signal(s) included in the RSSI measurements may include signals originating from devices on the same network as the wireless communication device (e.g., devices using the same communication protocols) and/or other nearby devices on a different network than the wireless device (e.g., devices using other communication protocols). In various examples, the pre-defined energy threshold may be defined by a manufacturer and/or a network operator (e.g., as part of installation and/or operation of the network).

Carrier sense measurements may include detecting one or more signal(s) using a same communication protocol (e.g., modulation and spreading schemes) as the wireless communication device (e.g., devices communicating on the same network as the wireless communication device). A carrier sense measurement may enable a measuring device to detect other devices operating on the same network (e.g., transmitting to the same node).

Path loss may refer to a decreasing energy of a signal as it travels through a medium (e.g., air). Wireless devices that are nearby (e.g., within 300 meters of) the wireless communication device may interfere with a signal transmitted from the wireless communication device, which may cause path loss. Excessive path loss may prevent a receiving device from receiving the signal.

The CCA measurements of the present disclosure may be utilized during one or more SIFS and/or LIFS period(s) following transmission, after a signal has failed to reach its destination after a certain number of retry attempts, when an acknowledgement is not received following transmission, and/or selectively as determined by a user of the wireless communication device. Detecting path loss after transmitting a signal may reduce a time needed to transmit a signal and reduce power consumption by performing CCA measurements less often compared to conventional systems that perform CCA measurements prior to transmission.

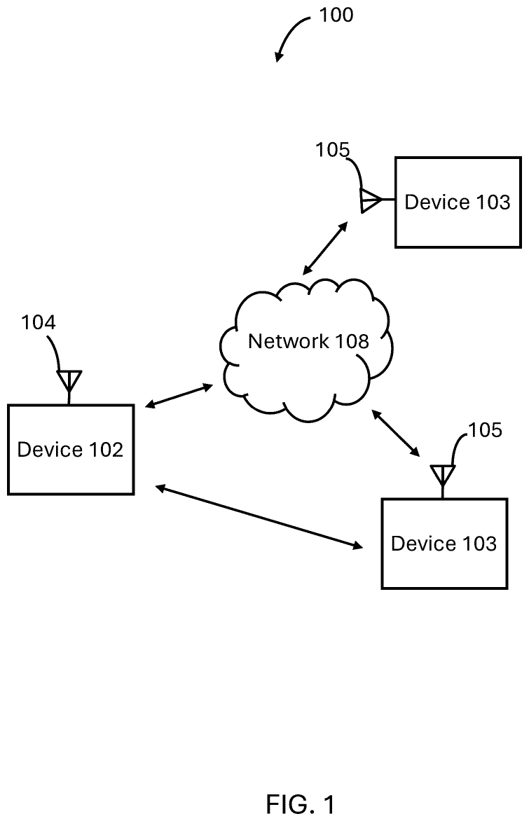

FIG. 1 illustrates an example system 100 including a wireless communication device 102, wireless communication devices 103, and a communications network 108. The wireless communication device 102 may communicate with other devices over the network 108 (e.g., through an access point) and/or directly with the devices 103.

The wireless communication device 102 includes an antenna 104 for transmitting and receiving signals. The wireless communication devices 103 respectively include an antenna 105 for transmitting and receiving signals. The antenna 104 and the antennas 105 may be any kind of antenna utilized by low power communication devices, such as dipole antennas, patch antennas Yagi antennas, chip antennas, printed circuit board (PCB) antennas, and the like. The antennas 104, 105 may include either directional or omnidirectional antennas. Each of the antennas 104, 105 may include more than one antenna (e.g., an antenna array and/or separate receiving/transmitting antennas) without departing from the spirit of the present disclosure.

The communication network 108 generally allows communication between the wireless communication devices 102, 103. The communication network 108 may include the Internet, cellular communication networks, local area networks, metro area networks, wide area networks, cloud networks, plain old telephone service (POTS) networks, and the like, or combinations thereof. The communication network 108 may be wired, wireless, or combinations thereof and may include components such as modems, gateways, switches, routers, hubs, access points, repeaters, towers, and the like. The devices 102, 103 may, for example, connect to the communication network 108 either through wires, such as electrical cables or fiber optic cables, or wirelessly, such as radiofrequency (RF) communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, IEEE 804.15 standard, such as ZigBee™, or combinations thereof.

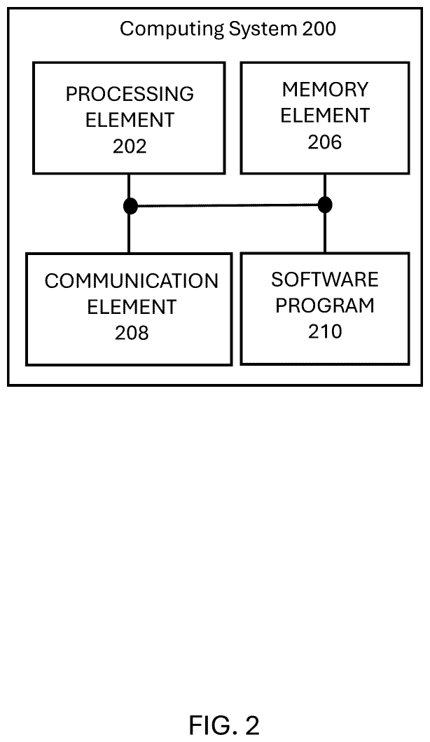

FIG. 2 illustrates a computing system 200. The computing system 200 may include at least one processing element 202, at least one memory element 206, a communication element 208, and a software program 210. In various examples, the computing system 200 may be a wireless communication device (e.g., the wireless communication devices 102, 103 of FIG. 1), a wireless base station/access point, and/or another computing device configured to perform some and/or all operations of the various examples of the present disclosure, without limitation.

The software program 210 may be configured with instructions for performing and/or enabling performance of at least some of the steps set forth herein. In an example, the software program 210 comprises instructions stored on computer-readable media of memory element 206.

The communication element 208 generally allows communication between the computing system 200 and a communication network (e.g., the communication network 108 of FIG. 1). The communication element 208 may include signal or data transmitting and receiving circuits, such as antennas, amplifiers, filters, mixers, oscillators, digital signal processors (DSPs), and the like. The communication element 208 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard, such as WiFi, IEEE 802.16 standard, such as WiMAX, Bluetooth™, IEEE 804.15 standard, such as ZigBee™, or combinations thereof. In addition, the communication element 208 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 208 may establish communication through connectors or couplers that receive metal conductor wires or cables, like Cat 6 or coax cable, which are compatible with networking technologies such as ethernet. In certain examples, the communication element 208 may also couple with optical fiber cables. The communication element 208 may respectively be in communication with the processing element 202 and/or the memory element 206.

The memory element 206 may include electronic hardware data storage components such as read-only memory (ROM), programmable ROM, erasable programmable ROM, random-access memory (RAM) such as static RAM (SRAM) or dynamic RAM (DRAM), solid state drives (SSDs), cache memory, hard disks, floppy disks, optical disks, flash memory, thumb drives, universal serial bus (USB) drives, or the like, or combinations thereof. In some examples, the memory element 206 may be embedded in, or packaged in the same package as, the processing element 202. The memory element 206 may include, or may constitute, a “computer-readable medium.” The memory element 206 may store the instructions, code, code segments, software, firmware, programs, applications, apps, services, daemons, or the like that are executed by the processing element 202. In various examples, the memory element 206 stores the software applications/program 210. The memory element 206 may also store settings, data, documents, sound files, photographs, movies, images, databases, and the like.

The processing element 202 may include electronic hardware components such as processors. The processing element 202 may include digital processing unit(s). The processing element 202 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 202 may generally execute, process, or run instructions, code, code segments, software, firmware, programs, applications, apps, processes, services, daemons, or the like. For instance, the processing element 202 may execute the software applications/program 210. The processing element 202 may also include hardware components such as finite-state machines, sequential and combinational logic, and other electronic circuits that can perform the functions necessary for the operation of the current disclosure. The processing element 202 may be in communication with the other electronic components through serial or parallel links that include universal busses, address busses, data busses, control lines, and the like.

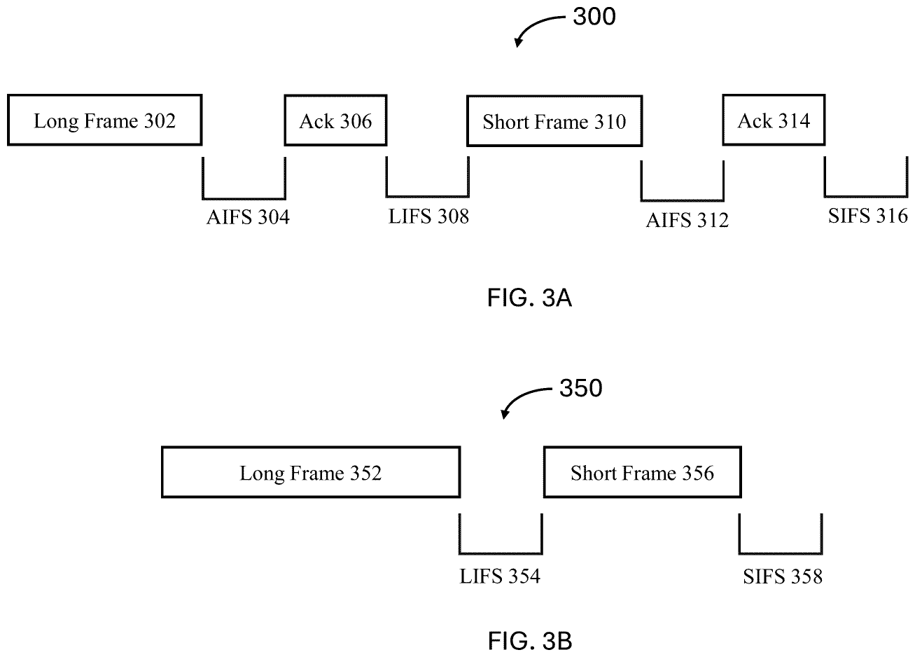

Turning to FIG. 3A, a timing diagram 300 includes a long frame 302, an acknowledgment interframe spacing (AIFS) period 304, an acknowledgment 306, a LIFS period 308, a short frame 310, an AIFS period 312, an acknowledgment 314, and a SIFS period 316.

A wireless communication device (e.g., the wireless communication device 102 of FIG. 1) may transmit the long frame 302 as a first signal to a receiving device (e.g., one of the wireless communication devices 103 of FIG. 1). Subsequent to transmitting the long frame 302, the device will wait to receive the acknowledgment 306 during the AIFS period 304. The device may perform CCA measurements during the AIFS period 304 before receiving the acknowledgement 306. The LIFS period 302 follows the AIFS 304. The device may perform CCA measurements during the LIFS period 302. Each time the device transmits a long frame 302, a LIFS period 308 will follow subsequent to the AIFS period 304.

Subsequent to the LIFS period 308, the device may transmit the short frame 310. Following transmission of the short frame 310, the device will wait for the acknowledgment signal 314 during the AIFS period 312. The device may perform CCA measurements during the AIFS period 312. The SIFS period 316 may follow the AIFS period 312. The device may perform CCA measurements during the SIFS period 316. Each time the device transmits a short frame 310, a SIFS period 316 will follow subsequent to the AIFS period 312.

Turning to FIG. 3B, a timing diagram 350 includes a long frame 352, a LIFS period 354, a short frame 356, and a SIFS period 358. A wireless communication device (e.g., the wireless communication device 102 of FIG. 1) may transmit the long frame 352 to a receiving device (e.g., one of the wireless communication devices 103 of FIG. 1). The LIFS period 354 may be subsequent to transmission of the long frame 352. The device may perform CCA measurements during the LIFS period 354. Subsequent to the LIFS period 354, the device may transmit the short frame 356. The SIFS period 358 may follow transmission of the short frame 356. The device may perform CCA measurements during the SIFS period 358.

In various examples, the device may not transmit a long frame followed by a short frame, as shown in FIGS. 3A, 3B. Rather, the device may transmit multiple short frames with corresponding SIFS periods following each short frame and/or multiple long frames, with a LIFS period following each long frame.

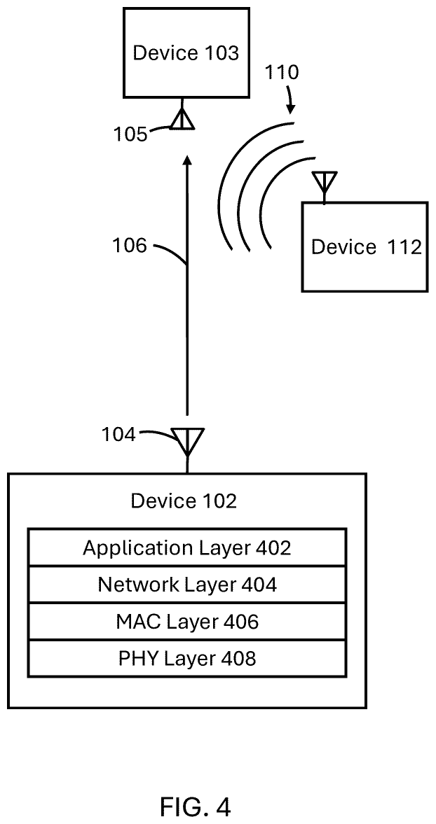

Turning to FIG. 4, the device 102 may transmit a signal 106 to the device 103. A device 112 may transmit a signal 110. The device 112 may be a wireless communications device similar to the wireless communication devices 103 described in connection with FIG. 1. The signal 110 may interfere with the signal 106, causing path loss.

The device 102 may include a protocol stack including an application layer 402, a network layer 404, a media access control (MAC) layer 406, and a physical (PHY) layer 408. Generally, the application layer 402 may define various addressing objects and may include various applications set by a manufacturer. The network layer 404 may provide an interface between the application layer 402 and the MAC layer 406 and may control signal routing, security, and structure. The MAC layer 406 may provide an interface between the network layer 404 and the PHY layer 408 and may manage basic message handling and congestion control. The MAC layer 406 may perform CCA assessments and other operations in accordance with IEEE 804.15.4 communication protocols (e.g., in accordance with the IEEE 804.15.4 communication protocols published and in effect as of the initial filing date of the present disclosure). The PHY layer 408 may manage physical operations of the device 102, such as transmission parameters.

The signal 106 may include a data packet. The data packet may include a long frame or a short frame, as described in connection with FIGS. 3A, 3B. The device 102 may perform a CCA assessment after transmitting the signal 106. As a result of the CCA assessment, the device 102 may detect that a signal (e.g., the signal 110) may have interfered with the signal 106. Accordingly, the device 102 may adjust one or more transmission parameters and retransmit the data packet as a retransmitted signal.

The one or more adjusted transmission parameters may include a transmission gain, a transmission angle, and/or a transmission time. Adjusting the transmission gain may include adjusting an amplitude of the signal that is output from the antenna of the device 102. For example, the transmission gain may be increased to avoid path loss. Adjusting the transmission angle may include changing a directional pattern of the antenna through phase adjustments (in examples where the antenna 104 includes multiple antennas, such as a phased array) and/or physical movement (e.g., tilt, rotation) of the antenna such that it produces a signal in the direction of the device 103. Adjusting transmission time may include adding a delay before retransmitting the data packet to avoid transmitting at the same time as the device 112.

In various examples, the device 102 may determine to perform a CCA assessment after a certain number of number of retry attempts have been made. A retry attempt may include retransmitting a data packet that was not or may not have been successfully received by a receiving device (e.g., the device 103). For example, the MAC layer 406 may include a retry counter. A count may be added to the retry counter each time a data packet is retransmitted. The device 102 may determine that a signal has not been received by the receiving device when an acknowledgement signal is not received during an AIFS period (e.g., the acknowledgment 306 is not received during the AIFS period 304). Alternatively, the device 102 may receive a signal (e.g., from the device 103) indicating that transmitted data frames are not being received.

In another example, a user may determine that the receiving device is not receiving transmissions from the device 102 either manually or through, for example, a monitoring system configured to submit an alert when expected signals are not received from a device for a certain period of time. In this example, the user may initiate the CCA assessment following transmission of a signal by the device 102. In some examples, the receiving device may include the monitoring system and may automatically send a signal to the device 102 that expected transmissions are not being received, which may trigger a CCA assessment by the device 102 following transmission of a signal.

In various examples, the device 102 may perform the CCA assessment in an AIFS period following transmission of a long or short frame, and/or during a LIFS or SIFS period following transmission of the long or short frame. The CCA assessment may be performed within, for example, two hundred (200) μs, and preferably less than one hundred ninety two (192) μs.

Performing the CCA assessment following transmission of a signal may reduce an amount of time needed to transmit compared to conventional devices that perform CCA assessments prior to transmission. The CCA assessment being performed after the transmission may enable the device 102 to determine a likelihood that a transmitted signal was successfully received (e.g., by determining whether the communication channel and/or communication medium is busy in the time immediately following transmission). Accordingly, the device 102 may retry the transmission if the signal was not likely received or may determine that the signal was successfully received.

Through hardware, software, firmware, or various combinations thereof, any of the processing elements (e.g., the processing element 202 of FIG. 2) may—alone or in combination with other processing elements—be configured to perform the operations of examples of the present disclosure. The examples described herein in connection with the attached drawing figures are intended to describe aspects of the disclosure in sufficient detail to enable those skilled in the art to practice the disclosure. Other examples can be utilized and changes can be made without departing from the scope of the present disclosure. The system may include additional, less, or alternate functionality and/or device(s), including those discussed elsewhere herein. The above and below detailed description is, therefore, not to be taken in a limiting sense. The scope of the present disclosure is defined only by the appended claims, along with the full scope of equivalents to which such claims are entitled, unless otherwise expressly stated and/or readily apparent to those skilled in the art from the description.

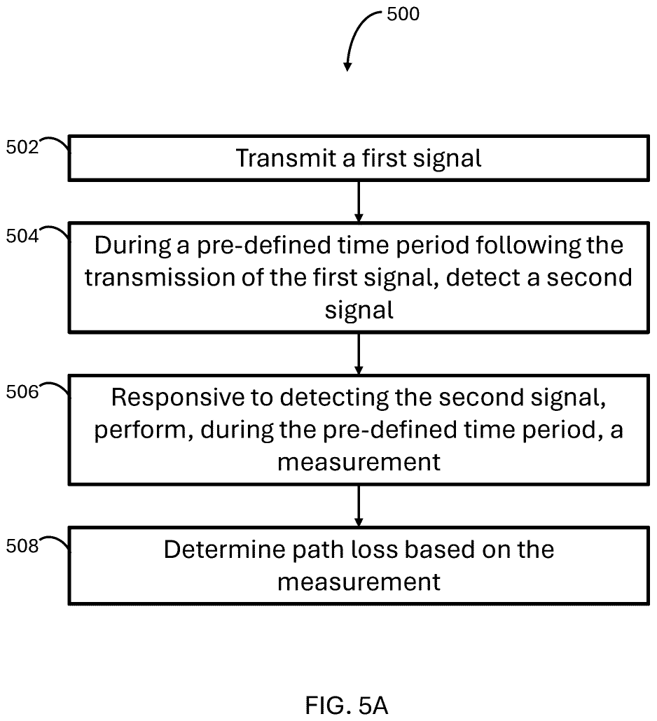

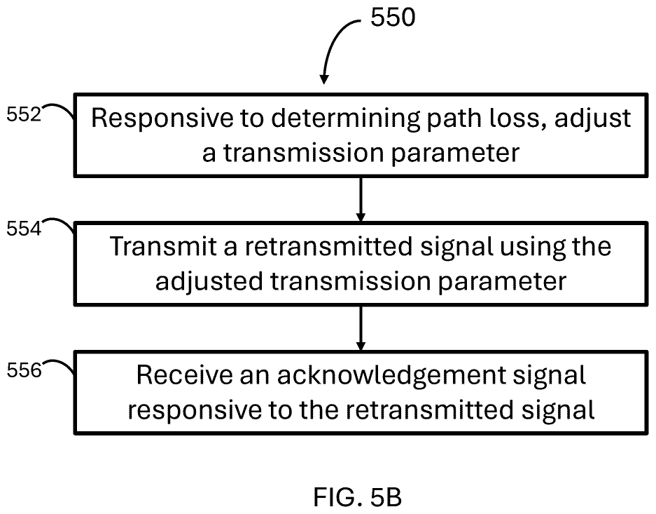

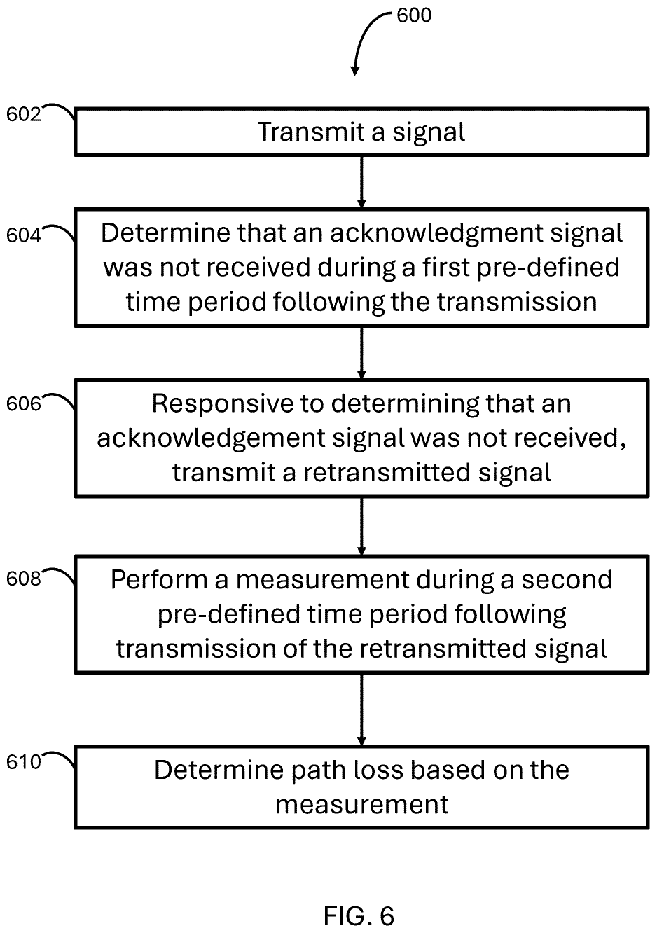

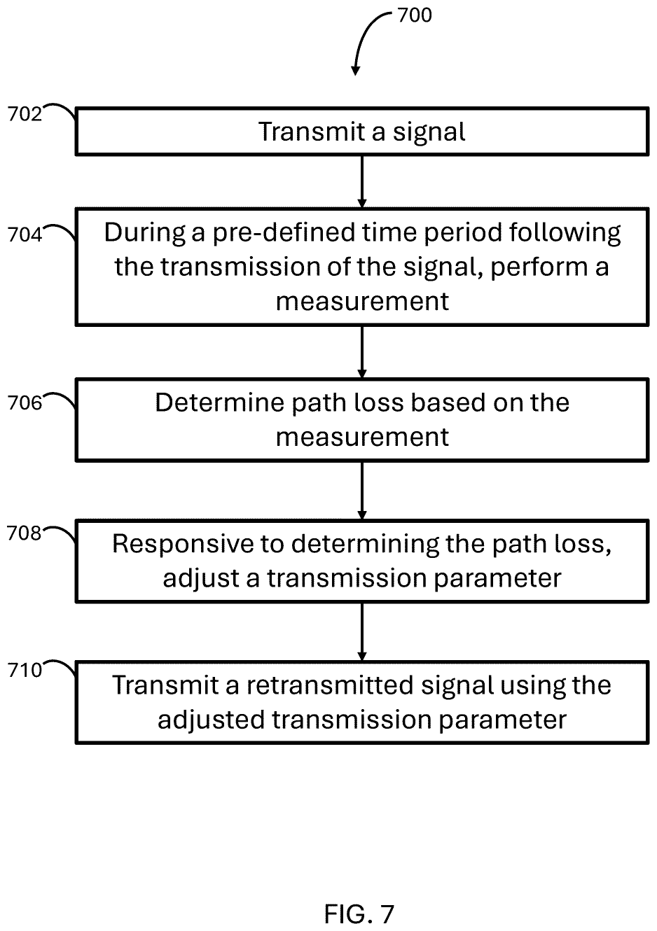

FIG. 5A illustrates an example method 500 for path loss determination based on measurements following transmission of a signal. The method 500 may be performed by a wireless communication device (e.g., the wireless communication device 102 of FIG. 1). The method 500 may be performed in connection with any one or more of the method 550 described in connection with FIG. 5B, the method 600 described in connection with FIG. 6, and/or the method 700 described in connection with FIG. 7, within the scope of various examples.

At operation 502, a first signal may be transmitted. The first signal may include a data packet. The data packet may include a long data frame or a short data frame. The first signal may be transmitted from the wireless communication device to a receiving device (e.g., one of the devices 103 of FIG. 1). The first signal may be transmitted over a communication network (e.g., the network 108 of FIG. 1). The network may include a plurality of devices using a CSMA-CA communication protocol scheme.

At operation 504, one or more second signal(s) may be detected during a pre-defined time period following the transmission of the first signal. The pre-defined time period may be a SIFS or a LIFS, depending on whether the signal includes a short frame or a long frame, respectively. In some examples, the second signal may be detected during an AIFS signal, as described in connection with FIG. 3A.

The second signal(s) may include signal(s) transmitted by one or more of the devices on the network (e.g., one of the devices 103 that is not the receiving device) or may be transmitted by one or more nearby devices operating on a different communications network (e.g. a Wi-Fi or cellular network). The second signal(s) may be detected as part of a CCA assessment.

At operation 506, in response to detecting the second signal(s), one or more measurements may be performed as part of the CCA assessment. The CCA assessment may include measuring a signal strength of the second signal(s) and comparing the signal strength to an RSSI threshold and/or performing a carrier sense measurement to determine whether the device(s) transmitting the second signal(s) are operating using the same communication protocols as the wireless communications device.

At operation 508, path loss may be detected or determined based on the measurement. The path loss determination may include determining that the signal strength of the second signal exceeds the RSSI threshold and/or the device(s) transmitting the second signal(s) are operating using the same communication protocols as the wireless communication device. The path loss determination may indicate that the receiving device likely did not receive the first signal.

FIG. 5B illustrates an example method 550 for retransmitting a data packet following and/or responsive to a path loss determination, such as the path loss determination described in connection with operation 508 of FIG. 5. The method 550 may be performed by a wireless communication device (e.g., the wireless communication device 102 of FIG. 1).

In various examples, the method 550 may be performed in connection with any one or more of the method 500 described in connection with FIG. 5A (e.g., following the path loss determination of operation 508), the method 600 described with reference to FIG. 6, and/or the method 700 described in connection with FIG. 7, within the scope of the present examples.

At operation 552, one or more transmission parameters may be adjusted based on detecting path loss (e.g., as in operation 508 of FIG. 5). The one or more transmission parameters may include a transmission gain, a transmission angle, and/or a transmission time, as described in connection with FIG. 4.

At operation 554, a retransmitted signal may be transmitted to a receiving device using the adjusted parameter. The retransmitted signal may include a data packet that was transmitted in an original signal (e.g., the first signal described in connection with FIG. 5A).

At operation 556, an acknowledgment signal may be received from the receiving device in response to retransmitting the data packet as the retransmitted signal. The acknowledgement signal may indicate that the data packet was successfully received by the receiving device.

FIG. 6 illustrates an example method 600 for path loss determination based on measurements following transmission of a signal. The method 600 may be performed by a wireless communication device (e.g., the wireless communication device 102 of FIG. 1).

In various examples, the method 600 may be performed in connection with any one or more of the method 500 described in connection with FIG. 5A, the method 550 described in connection with FIG. 5B, and/or the method 700 described in connection with FIG. 7, within the scope of the present examples.

At operation 602, a signal may be transmitted. The signal may include a data packet. The signal may be transmitted in the same manner as described with reference to operation 502 of the method 500 of FIG. 5, with redundant description thereof being avoided for brevity.

At operation 604, a determination may be made that an acknowledgement signal was not received during a first pre-defined time period following the transmission. The first pre-defined time period may be a SIFS period or a LIFS period, depending on whether the signal includes a short frame or a long frame. The wireless communication device may expect to receive an acknowledgement signal in an AIFS period and determine the acknowledgement was not received during the SIFS or LIFS period following the AIFS period. In some examples, the first pre-defined time period may follow an AIFS period. Alternatively, the first pre-defined time period may include the AIFS period.

At operation 606, a retransmitted signal may be transmitted in response to determining the acknowledgement signal was not received. The retransmitted signal may include a same data packet as the originally transmitted signal. In response to retransmitting the signal, the wireless communication device may add a count to a retry counter (e.g., as described in connection to FIG. 4).

At operation 608, a measurement may be performed during a second pre-defined time period following transmission of the retransmitted signal. In various examples, the measurement may be performed in response to a predefined number of retry attempts, as indicated by the retry counter. In other examples, the measurement may be initiated by a user or monitoring system that has determined that one or more previously transmitted signals have not been received by the receiving device.

The measurement may include performing a CCA assessment in the same manner described in preceding sections, with redundant description thereof being avoided for brevity. The second pre-defined period may include a SIFS or LIFS period, as described in connection with the first pre-defined time period of operation 604. In some examples, the second pre-defined period may include an AIFS period.

At operation 610, path loss may be determined based on the measurement. The path loss may be determined in the same manner described in connection with operations 504 and 506 of the method 500 of FIG. 5, with redundant description thereof being avoided for brevity.

Following the determination of the path loss, the wireless communication device may adjust one or more transmission parameters and transmit a second retransmitted signal, as described in connection with the method 550 of FIG. 5B.

FIG. 7 illustrates an example method 700 for path loss determination based on measurements following transmission of a data packet. The method 700 may be performed by a wireless communication device (e.g., the wireless communication device 102 of FIG. 1).

In various examples, the method 700 may be performed in connection with any one or more of the method 500 described in connection with FIG. 5A, the method 550 described in connection with FIG. 5B, and/or the method 600 described in connection with FIG. 6, within the scope of the present examples.

At operation 702, a signal may be transmitted. The signal may include a data packet. The signal may be transmitted in the same manner as described with reference to operation 502 of the method 500 of FIG. 5, with redundant description thereof being avoided for brevity.

At operation 704, one or more measurements may be performed during a pre-defined time period following the transmission of the signal. The measurement may include a CCA assessment, as described in more detail in preceding sections, with redundant description thereof being avoided for brevity. The pre-defined time period may include an AIFS period, a SIFS period, or a LIFS period, again as described in more detail above, with redundant description thereof being avoided for brevity.

At operation 706, path loss may be determined based on the one or more measurements. The path loss may be determined in the same manner described in connection with operations 504 and 506 of the method 500 of FIG. 5, with redundant description thereof being avoided for brevity.

At operation 708, one or more transmission parameters may be adjusted responsive to or based on determining the path loss. The one or more parameters may include a transmission gain, a transmission angle, and/or a transmission timing. The one or more transmission parameters may be adjusted in the same manner described in connection with operation 552 of the method 550 of FIG. 5B, with redundant description thereof being avoided for brevity.

At operation 710, a retransmitted signal may be transmitted using the adjusted transmission parameter(s) in the same manner described in connection with operation 554 of the method 550 of FIG. 5B, with redundant description thereof being avoided for brevity.

In various examples, an acknowledgement signal may be received following the transmission of the retransmitted signal, as described in connection with FIG. 3A. In other examples, an acknowledgement signal is not expected to be received and is not received, as described in connection with FIG. 3B.

### Feature Combinations

According to various examples of the present disclosure, a wireless communication device may include a communication element, non-transitory computer-readable storage media including instructions stored thereon, and at least one processor. The instructions, when executed by the at least one processor, may cause the at least one processor to: transmit, by the communication element, a first signal; during a pre-defined time period following the transmission of the first signal, detect, by the communication element, a second signal; responsive to detecting the second signal, perform, during the pre-defined time period, a measurement; and determine path loss based on the measurement.

According to various examples of the present disclosure, a wireless communication device may include a communication element, non-transitory computer-readable storage media including instructions stored thereon, and at least one processor. The instructions, when executed by the at least one processor, may cause the at least one processor to: transmit, by the communication element, a signal; determine that an acknowledgment signal was not received during a first pre-defined time period following the transmission; responsive to determining that an acknowledgement signal was not received, transmit, by the communication element, a retransmitted signal; perform a measurement during a second pre-defined time period following transmission of the retransmitted signal; and determine path loss based on the measurement.

According to various examples of the present disclosure, a wireless communication device may include a communication element, non-transitory computer-readable storage media including instructions stored thereon, and at least one processor. The instructions, when executed by the at least one processor, may cause the at least one processor to: transmit, by the communication element, a signal; during a pre-defined time period following the transmission of the signal, perform a measurement; determine path loss based on the measurement; responsive to determining the path loss, adjust a transmission parameter; and transmit, by the communication element, a retransmitted signal using the adjusted transmission parameter.

In combination with any of the previous examples, a measurement may include an RSSI measurement.

In combination with any of the previous examples, a measurement may include a carrier sense measurement.

In combination with any of the previous examples, a transmission parameter may include one or more of: a transmission gain, a transmission angle, or a transmission time.

In combination with any of the previous examples, instructions, when executed by at least one processor may cause the at least one processor to: transmit, by a communication element, a retransmitted signal using an adjusted transmission parameter; and receive, by the communication element, an acknowledgement signal responsive to the retransmitted signal.

In combination with any of the previous examples, a measurement may be performed based at least in part on a retry number associated with transmission of the first signal.

In combination with any of the previous examples, a measurement may be performed based at least in part on a user selection.

In combination with any of the previous examples, a pre-defined time period may be one of: a short interframe spacing (SIFS) period or a long interframe spacing (LIFS) period.

In combination with any of the previous examples, a wireless communication device may be a low power communication device.

### General Considerations

In this description, references to “one embodiment”, “an embodiment”, “embodiments”, “an example”, “one example”, or “examples” mean that the feature or features being referred to are included in at least one embodiment or example of the technology. Separate references to “one embodiment”, “an embodiment”, “embodiments”, “an example”, “one example”, or “examples” in this description do not necessarily refer to the same embodiment or example and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein, unless otherwise expressly stated and/or readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventors.

What is claimed is:

1. A wireless communication device comprising:
a communication element;
non-transitory computer-readable storage media including instructions stored thereon; and
at least one processor, the instructions, when executed by the at least one processor, causing the at least one processor to:
transmit, by the communication element, a first signal;
during a pre-defined time period following the transmission of the first signal, detect, by the communication element, a second signal;
responsive to detecting the second signal, perform, during the pre-defined time period, a measurement; and
determine path loss based on the measurement.

2. The wireless communication device of claim 1, the measurement including a received signal strength indicator (RSSI) measurement.

3. The wireless communication device of claim 1, the measurement including a carrier sense measurement.

4. The wireless communication device of claim 1, the instructions, when executed by the at least one processor, causing the at least one processor to:
responsive to determining the path loss, adjust a transmission parameter.

5. The wireless communication device of claim 4, the transmission parameter including one or more of: a transmission gain, a transmission angle, or a transmission time.

6. The wireless communication device of claim 4, the instructions, when executed by the at least one processor, causing the at least one processor to:
transmit, by the communication element, a retransmitted signal using the adjusted transmission parameter; and
receive, by the communication element, an acknowledgement signal responsive to the retransmitted signal.

7. The wireless communication device of claim 1, the measurement being performed based at least in part on a retry number associated with transmission of the first signal.

8. The wireless communication device of claim 1, the measurement being performed based at least in part on a user selection.

9. The wireless communication device of claim 1, the pre-defined time period being one of: a short interframe spacing (SIFS) period or a long interframe spacing (LIFS) period.

10. The wireless communication device of claim 1, the wireless communication device being a low power communication device.

11. A wireless communication device comprising:
a communication element;
non-transitory computer-readable storage media including instructions stored thereon; and
at least one processor, the instructions, when executed by the at least one processor, causing the at least one processor to:
transmit, by the communication element, a signal;
determine that an acknowledgment signal was not received during a first pre-defined time period following the transmission;
responsive to determining that an acknowledgement signal was not received, transmit, by the communication element, a retransmitted signal;
perform a measurement during a second pre-defined time period following transmission of the retransmitted signal; and
determine path loss based on the measurement.

12. The wireless communication device of claim 11, the measurement including a received signal strength indication (RSSI) measurement.

13. The wireless communication device of claim 11, the measurement including a carrier sense measurement.

14. The wireless communication device of claim 11, the instructions, when executed by the at least one processor, causing the at least one processor to:
responsive to determining the path loss, adjust a transmission parameter; and
transmit, by the communication element, a second retransmitted signal using the adjusted transmission parameter.

15. The wireless communication device of claim 14, the transmission parameter including one or more of: a transmission gain, a transmission angle, or a transmission time.

16. The wireless communication device of claim 11, the first and second pre-defined time periods each including one of: a short interframe spacing (SIFS) period or a long interframe spacing (LIFS) period.

17. The wireless communication device of claim 11, the wireless communication device being a low power communication device.

18. A wireless communication device comprising:
a communication element;
non-transitory computer-readable storage media including instructions stored thereon; and
at least one processor, the instructions, when executed by the at least one processor, causing the at least one processor to:
transmit, by the communication element, a signal;
during a pre-defined time period following the transmission of the signal, perform a measurement;
determine path loss based on the measurement;
responsive to determining the path loss, adjust a transmission parameter; and
transmit, by the communication element, a retransmitted signal using the adjusted transmission parameter.

19. The wireless communication device of claim 18, the pre-defined time period being one of: a short interframe spacing (SIFS) period or a long interframe spacing (LIFS) period.

20. The wireless communication device of claim 18, the transmission parameter including one or more of: a transmission gain, a transmission angle, or a transmission time.
